(19) United States
(12) Patent Application Publication
(10) Pub. No.: US 2016/0330941 A1
(43) Pub. Date: Nov. 17, 2016

(54) GREEN CULTIVATED POOL STRUCTURE

(71) Applicant: TRUE TEN INDUSTRIAL CO., LTD., Taichung City (TW)

(72) Inventors: SHUN-TSUNG LU, TAICHUNG CITY (TW); TA-WEI LU, TAICHUNG CITY (TW)

(21) Appl. No.: 14/709,456

(22) Filed: May 11, 2015

(51) Int. Cl. A01K 63/00; A01K 63/06; A01G 31/00; A01K 63/04

(52) U.S. Cl. CPC A01K 63/006; A01K 63/042; A01K 63/06; A01K 63/045; A01G 31/00

(57) ABSTRACT

Disclosed is a green cultivated pool structure. The water in the reservoir of the cultivated pool flows naturally from the high-bottom water storage portion toward the low-bottom water storage portion, and the water in the drainage trough flows naturally from the first drainage portion toward the second drainage portion, thereby achieving the natural circulation and green environmental protection.

### (a) TECHNICAL FIELD OF THE INVENTION

The present invention relates to a green cultivated pool structure of natural circulation and green environmental protection.

### (b) DESCRIPTION OF THE PRIOR ART

Currently, hydroponic cultivation pools are designed only for plant cultivation. If a breeder wants to have plants and water animals cultivated simultaneously, two kinds of cultivation pools must be equipped to do such kind of cultivation: one is for plant cultivation and another animal breeding. In addition, a disturbance device is further needed to improve the water quality of water animal breeding.

### SUMMARY OF THE INVENTION

The main purpose of the present invention is to let water be circulated naturally without external aid and allow plants and water animals to be co-existed through the adverse level change of a water reservoir and drainage trough.

To achieve the object mentioned above, a green cultivated pool structure of the present invention includes a water reservoir, first drainage portion, second drainage portion and drainage trough, where the bottom of the reservoir is formed with an inclined angle which defines a high-bottom water storage portion and low-bottom water storage portion, the first drainage portion being defined adjacent to the low-bottom water storage portion and second drainage portion the high-bottom water storage portion. Furthermore, the two ends of the drainage trough are respectively in flow communication with the first drainage portion and second drainage portion, and the height of the bottom face of the drainage trough become lower gradually from the first drainage portion toward the second drainage portion, thereby allowing the water in the reservoir to flow naturally from the high-bottom water storage portion toward the low-bottom water storage portion and then enters the first drainage portion. Subsequently, the water in the drainage trough will flow naturally from the first drainage portion toward the second drainage portion, thereby achieving the natural circulation and green environmental protection.

### BRIEF DESCRIPTION OF THE DRAWINGS

FIG. 1 is a perspective view of the present invention;

FIG. 2 is a perspective view of the present invention viewed from another angle;

FIG. 3 is a cross-sectional view taken along line A-A shown in FIG. 1;

FIG. 4 is a cross-sectional view taken along line B-B shown in FIG. 2;

FIGS. 5 and 6 are schematic views respectively showing a water flow direction;

FIG. 7 shows a cultivation portion in a use state;

FIG. 8 shows a support device in a use state;

FIG. 9 is a partly schematically perspective view of the cultivated pool on which a hydraulic power generation device is installed;

FIG. 10 is a partly schematically perspective view of the cultivated pool on which a blowdown device is installed;

FIG. 11 is a partly schematically perspective view of the cultivated pool on which a sterilizing light generating device is installed;

FIG. 12 is a partly schematically perspective view of the cultivated pool in which a control device is used;

FIG. 13 is a partly schematically perspective view of the cultivated pool in which an external water supply device is used; and

FIG. 14 is a schematically perspective view showing a plurality of cultivated pools coupled in series according to the present invention.

### DETAILED DESCRIPTION OF THE PREFERRED EMBODIMENTS

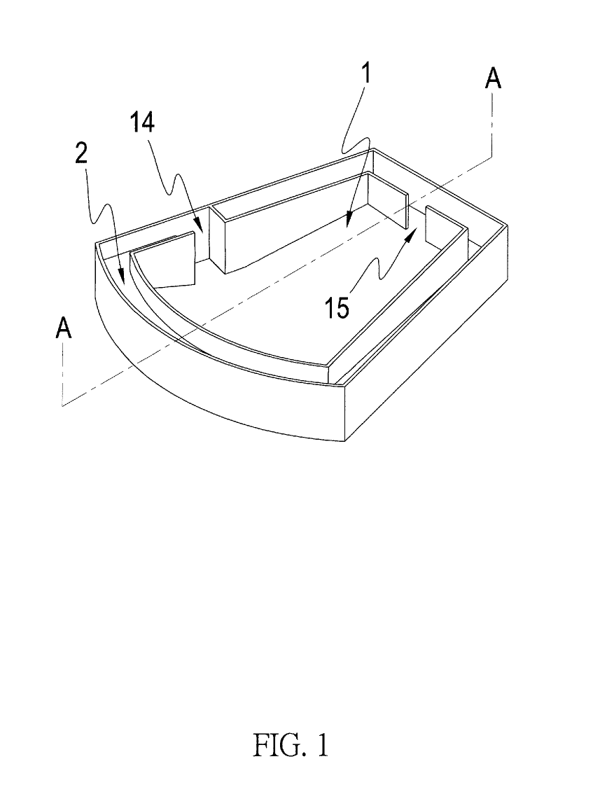

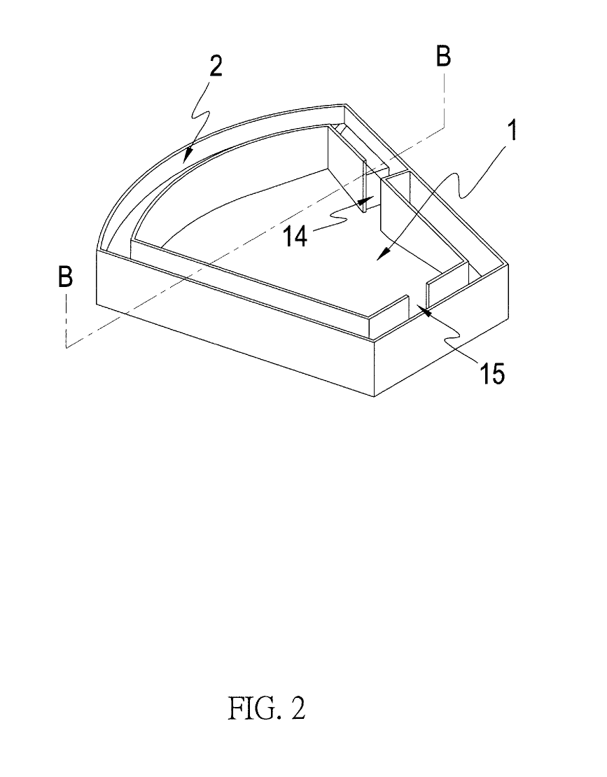

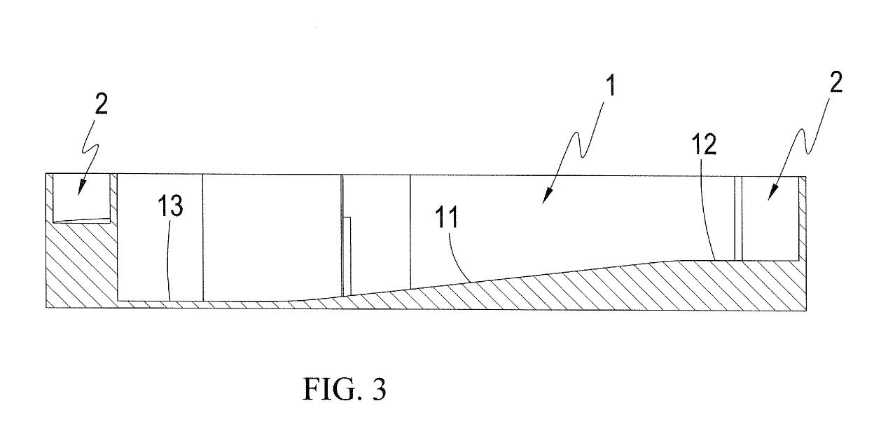

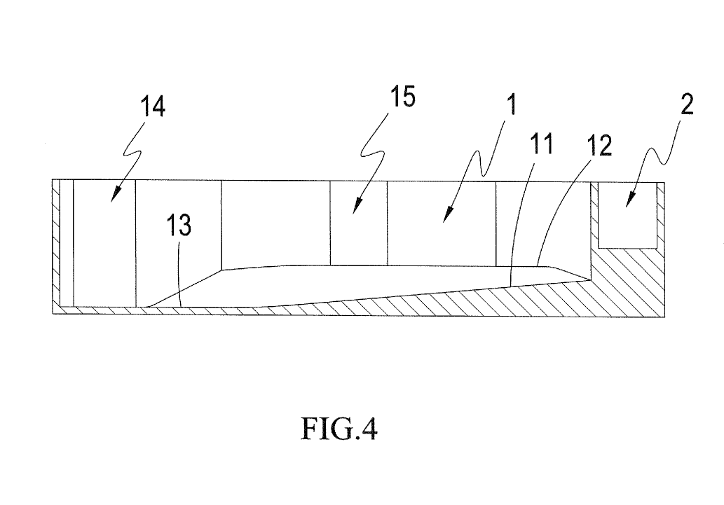

Referring to FIGS. 1 to 6, a green cultivated device includes:

a water reservoir 1, formed with at least one inclined angle 11 at the bottom thereof, and defining at least one high-bottom water storage portion 12 and at least one low-bottom water storage portion 13;

a first drainage portion 14, defined on the side wall face of the reservoir 1 and adjacent to the low-bottom water storage portion 13;

a second drainage 15, defined on the side wall face of the reservoir 1 and adjacent to the high-bottom water storage portion 12; and

a drainage trough 2, defined on one side of the reservoir 1, the two ends of the drainage trough 2 being respectively in flow communication with the first and second drainage portions 14,15, and the height of the bottom of the drainage trough 2 become lower gradually from the first drainage portion 14 toward the second drainage portion 15.

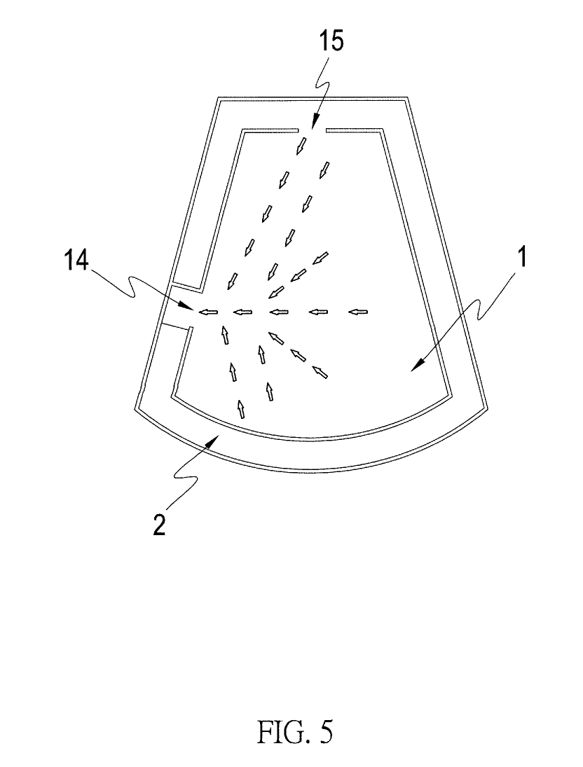

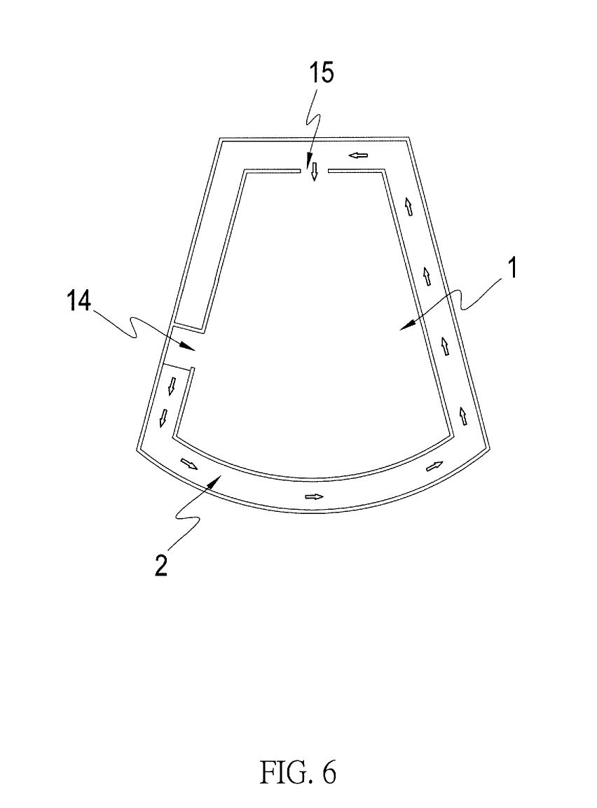

The structure mentioned above is the core technology of the present invention. First of all, the water reservoir 1 is explained; it can be seen clearly from the FIGS. 1 to 4 that the bottom of the reservoir 1 has at least one inclined angle 11 for angle change. In the embodiment, there are two inclined angle 11 due to the consideration of practical use convenience and effect, causing the entire pool bottom be formed into an approximate V-shaped body, the lowest location thereof being the low-bottom water storage portion 13 and the two ends thereof the high-bottom water storage portions 12 such that the water will flow to the first drainage portion 14; the overall flow direction of the water is indicated as arrows shown in FIG. 5. The water yield at the low-bottom water storage portion 13 is larger such that the pressure thereat is larger than other portions; utilizing such physical property allows the water to pass through the first drainage portion 14 smoothly; the water will then enter the drainage trough 2 after passing through the first drainage 14. Similarly, it can be seen clearly from FIGS. 1 to 4 that the bottom of the drainage trough 2 is changed in height, the bottom level being opposite to the one of the bottom of the reservoir 1; the bottom level of the drainage trough 2 nearer to the first drainage portion 14 is higher and nearer to the second drainage portion 15 is lower. Thus, it can be known that the water will flow from the first drainage portion 14 toward the second drainage 15 after flowing into the drainage trough 2; the overall flow direction of the water is indicated as arrows shown in FIG. 6. Thereupon, the water will flow into the reservoir 1 again after entering the drainage portion 15 such that the water can be circulated naturally in this way without external aid.

As a result, the structure of the present invention has been divided into two areas: the water reservoir 1 and drainage trough 2. In the case of actual use, the reservoir 1 mainly provide water animals with a moving and cultivation space, and the drainage trough 2 then provides the cultivation use for hydroponic plants. Therefore, the water animals cannot do harm to the hydroponic plants (e.g. biting the roots of the hydroponic plants) through this kind of structure, ensuring the balanced development and coexistence of the both.

Since the reservoir 1 is mainly used for the cultivation of water animals, the excrement of the water animals will drop to the pool bottom. Advantageously, the excrement will drop to the lowermost location of the bottom (i.e. the low-bottom water storage portion 13) naturally by means of the design of the inclined angle 11 mentioned above according to the present invention. As a result, the cleaning of the reservoir 1 can be carried out with respect to a small part of areas, and a large amount of excrement can then be removed effectively, thereby reducing the burden of the management.

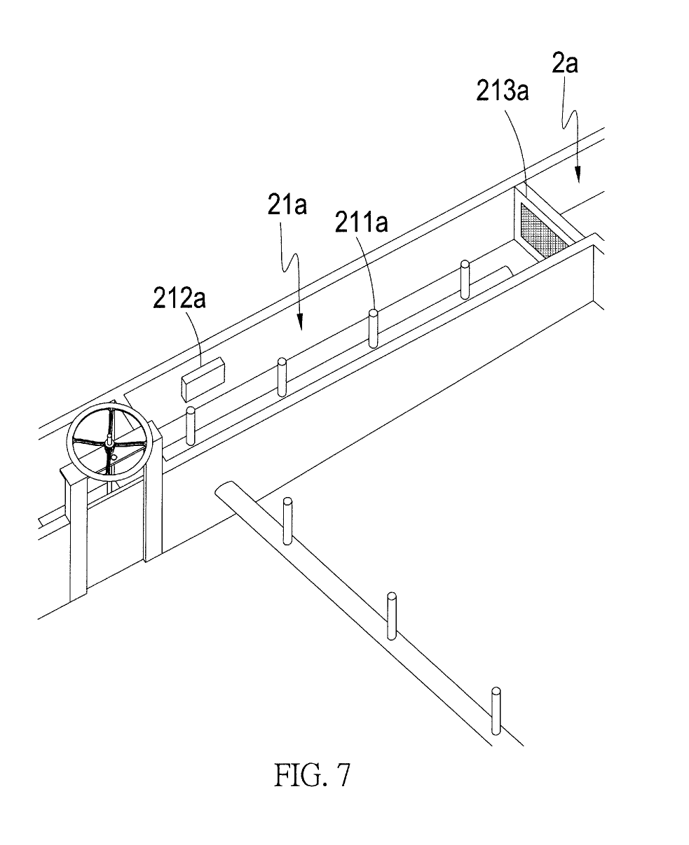

Referring to FIG. 7, a cultivation portion 21a allowing the water animals to move is extended from one end of the drainage trough 2a, and an oxygen supplying device 211a for the provision of oxygen in the water, a temperature controlling device 212a adapted to control the water temperature and a filter device 213a adapted to filter water impurities are configured on the cultivation portion 21a; the reason for having such kind of design lies in that the water inside the space of the cultivation portion 21a can be heated through the temperature controlling device 212a to prevent the water animals from being damaged (e.g. frozen to death) when the environmental temperature is too low, and the water animals will move to the cultivation portion 21a in winter by themselves based on animal survival instinct. Furthermore, taking into consideration the actual level factors, the space of the cultivation portion 21a is much smaller compared to the main body of the entire cultivated pool, several facilities must be depended on to improve the environment in order to allow all the water animals to survive in the cultivation portion 21a; the water in the cultivation portion 21a has enough oxygen content by means of the actuation of the oxygen supplying device 21a to assure that the water animals do not die due to hypoxia. On the other hand, taking into consideration the water quality in a small space, the filter device 213a is used to keep the water quality of the water inside the cultivation portion 21a well so as to assure that all the water animals are not damaged due to the environmental issues while gathering in the cultivation portion 21a.

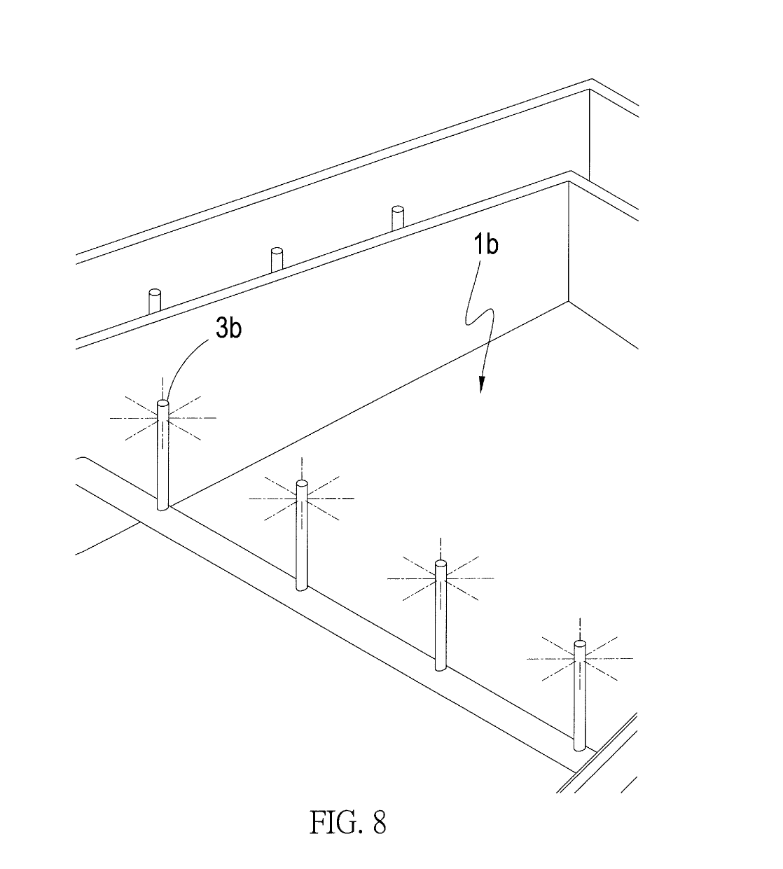

Referring to FIG. 8, continuation of the above, to provide a good cultivation environment for the reservoir 1b, it is necessary to provide the water animals with sufficient nutrient. Nutrient support by means of spraying is carried out to the reservoir 1b through a support device 3b, allowing the water animals to obtain all the conditions necessary for survival, thereby achieving the cultivation of the water animals.

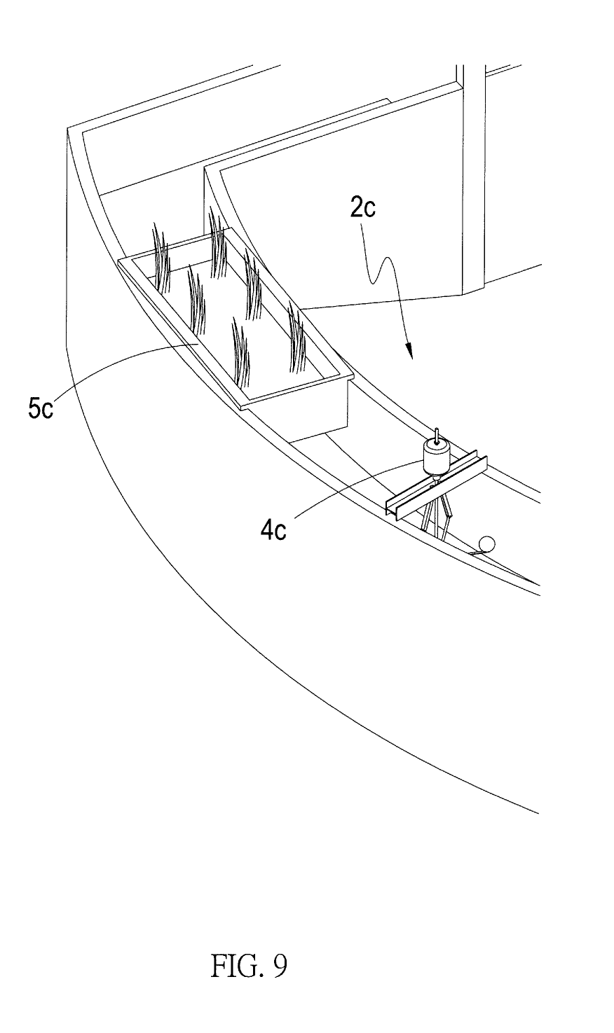

Referring to FIG. 9, it can be seen clearly from the above, in terms of the drainage trough 2c, the water therein will flow naturally due to the gradually lower level of the bottom thereof. In this regard, to utilize the natural flow of the water effectively to generate electric power, a hydraulic power generation device 4c is configured on the drainage trough 2c, thereby providing electric power for other facilities or collecting it for storage. Furthermore, a plant cultivation device 5c in which plants to be cultivated are placed is further configured on the drainage trough 2c. As a result, the quality of the water provided for the plants is very good because the water in the drainage trough 2c is flowing continuously; that is all that running water is never stale.

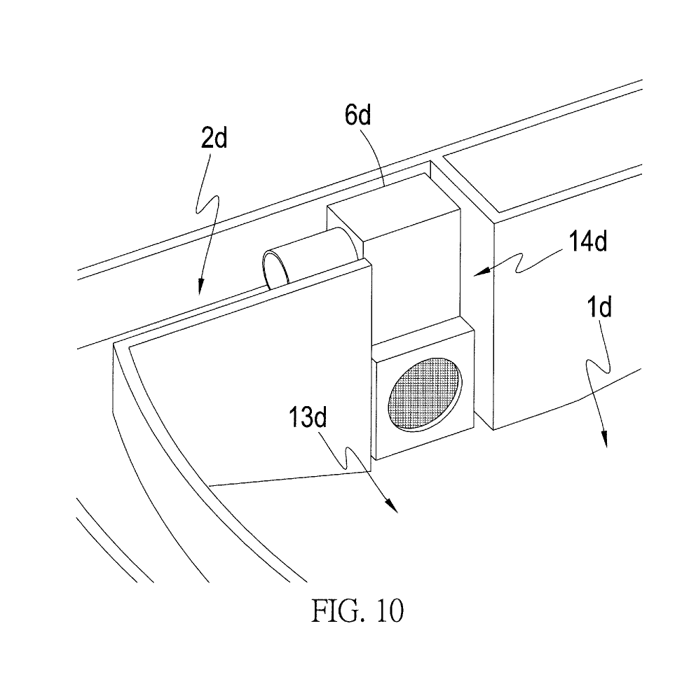

Referring to FIG. 10, continuation of the above, some excrement of the water animals or other filth will be accumulated on the low-bottom water storage portion 13 after the reservoir 1d have been in use for a period of time, and the water will flow to the drainage trough 2d because of the structure design. But, there will be bad influences on many sophisticated facilities configured on the drainage trough 2d after the excrement or filth enters the drainage trough 2d. In this regards, a blowdown device 6d adapted to filter water impurities is configured inside the drainage trough 2d on one side thereof near the first drainage portion 14d, thereby intercepting and blocking the above excrement or filth to assure of the quality of the water flowing into the drainage trough 2d. Therefore, the blowdown device 6d is used as a protection of the other facilities and improver of water quality.

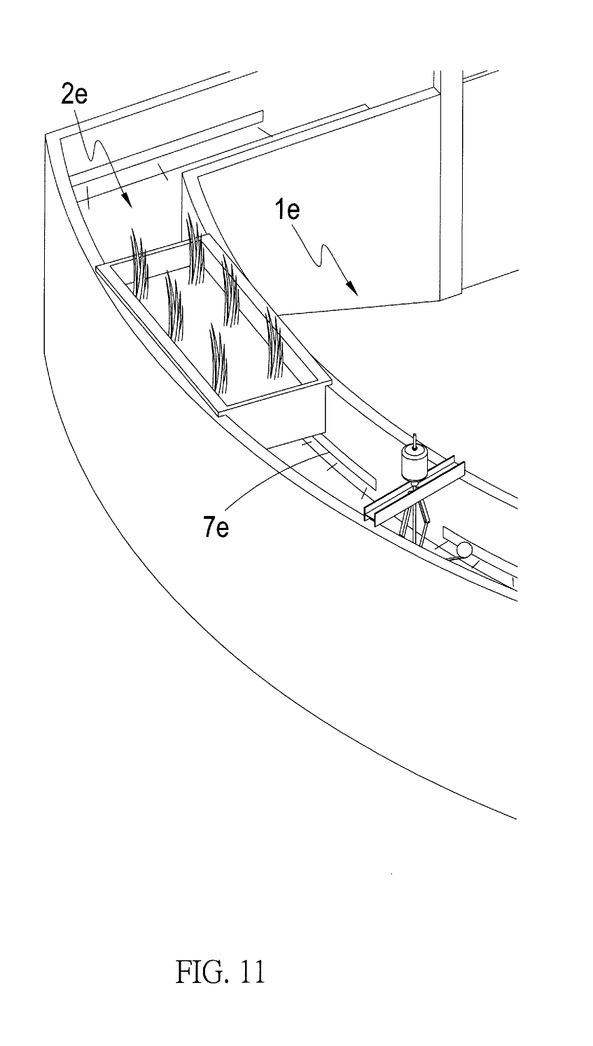

Referring to FIG. 11, continuation of the above, it can be known that the water quality is very important because the water animals are cultivated in the reservoir 1e. But, the water animals may generate excrement or filth. As a result, the water will lead to the proliferation of microorganisms or bacteria, and the environment in the reservoir 1e will be disadvantageous for the survival of the water animals if inhibition or some of necessary means are not carried out thereon. In this regards, a sterilizing light generating device 7e is configured on the drainage trough 2e; the sterilizing beams emitted from the device 7e will illuminate the flowing water in the drainage trough 2e to keep the water quality well. Furthermore, it can be known that the water will flow back into the reservoir 1e because of the above structure such that the water quality of the entire cultivated pool can be assured of.

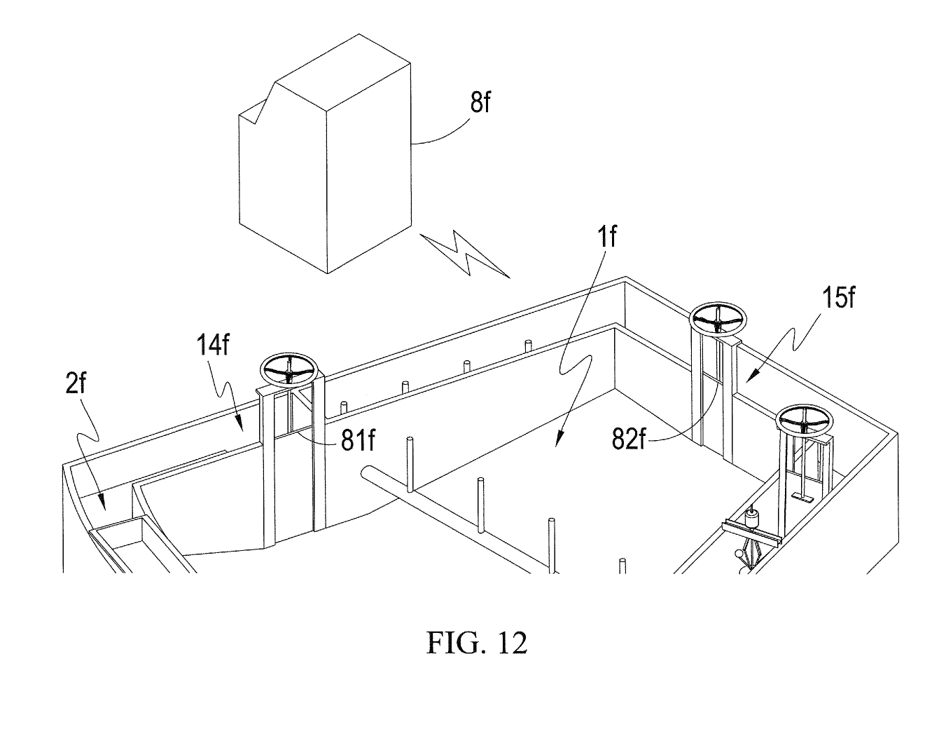

Referring to FIG. 12, to allow the water flow to be circulated naturally much better, the water replacement to be carried out, the above facilities to be replaced, or other applications to be performed, several facilities adapted to limit the water flow must be equipped. In this regard, a first water gate 81f and second water gate 82f are respectively coupled to the first drainage portion 14f and second drainage portion 15f, where the first and second water gates 81f, 82f are respectively in data connection with a control device 8f, which can drive the first and second water gates 81f, 82f to move synchronously so as to control the water flow rates of the reservoir 1f and drainage trough 2f Specifically, if it is intended to keep the natural circulation, the opening size of the first water gate 81f will be the same as the one of the second water gate 82f, which can be controlled by the control device 8f, thereby assuring of the balance of the water flow rates; if it is intended to clean the drainage trough 2f or carry out the replacement of the facilities configured thereon, the first water gate 81f is closed to stop the water entering the drainage trough 2f, allowing the drainage trough 2f to be in an anhydrous state so as to facilitate the management to carry out the operations; the applications can be carried out effectively and conveniently through such kind of structure operated in coordination with the device. Furthermore, the first water gate 81f and second water gate 82f may also be opened or closed manually through the operation units of the water gates in addition to the closing and opening thereof controlled by the control device 8f mentioned above. The application way thereof is the same as the above, and the details are omitted here.

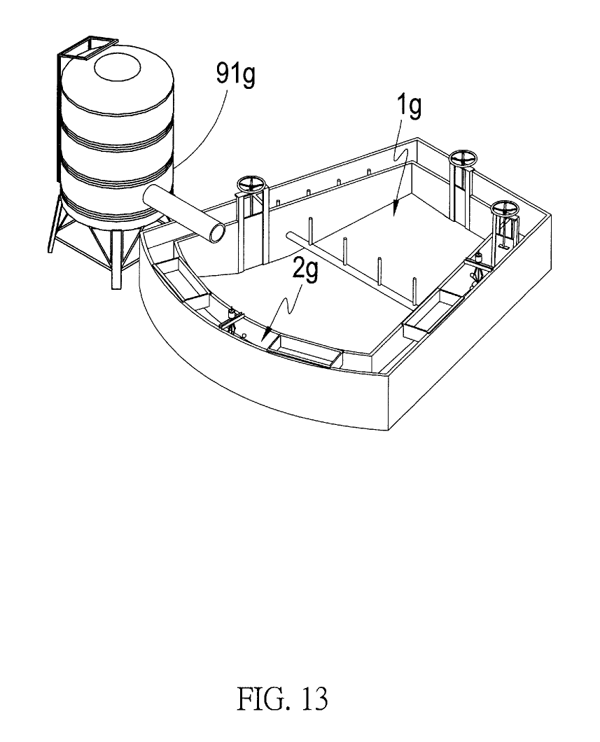

Referring to FIG. 13, the water in the reservoir 1g and drainage trough 2g will be vaporized or lost naturally because the both of them are semi-open spaces, and it will thus be harmful to the overall application if the water replenishment is not longer carried out. In this regard, an external water supply device 91g is connected to the reservoir 1g. The water in the reservoir 1g is replenished automatically by the external water supply device 91g when the level thereof is lower than a certain degree. As a result, the actuation of the external water supply device 91g can assure of the overall amount of water and use convenience.

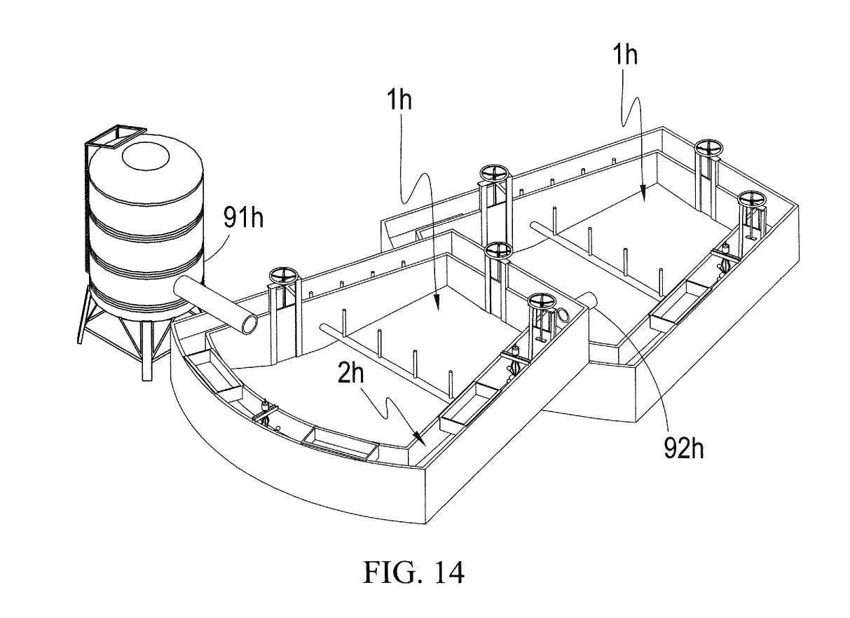

The explanations mentioned above are all related to the use conditions of an individual cultivated pool according to the present invention. Referring to FIG. 14, a connection portion 92h adapted to connect a plurality of cultivate pools in series is formed on one side of each drainage trough 2h when they are used together. Specifically, the water to be used as replenished water will flow continuously from the drainage trough 2h of one cultivated pool to the reservoir 1h of the subsequent cultivated pool; the first cultivated pool has an external water supply device 91h, and the subsequent cultivated pools are replenished with water from the former ones. As a result, the facility cost can be saved.

I claim:

1. A green cultivated pool structure, comprising:
a water reservoir, at least one inclined angle being formed on a bottom face thereof, said inclined angle defining at least one high-bottom water storage portion and at least one low-bottom water storage portion on said reservoir;
a first drainage portion, defined on a side wall face of said reservoir and adjacent to said low-bottom water storage portion;
a second drainage portion, defined on a side wall face of said reservoir and adjacent to said high-bottom water storage portion;
a drainage trough, defined on one side of said reservoir, two ends of said drainage trough being respectively in flow communication with said first drainage portion and second drainage portion, and a height of a bottom face of said drainage trough being decreased gradually from said first drainage portion toward said second drainage portion.

2. The structure according to claim 1, wherein a cultivation portion allowing water animals' activities is extended from one end of said second drainage portion of said drainage trough.

3. The structure according to claim 2, wherein said cultivation portion is configured with an oxygen supplying device for the provision of oxygen in said water, a temperature controlling device adapted to control water temperature and a filter device adapted to filter water impurities.

4. The structure according to claim 1, wherein a support device adapted for the provision of water nutrient is configured on said reservoir.

5. The structure according to claim 1, wherein at least one water power generation device is configured on said drainage trough.

6. The structure according to claim 1, wherein at least one plant cultivation device adapted to carry out hydroponic plant cultivation is configured on said drainage trough.

7. The structure according to claim 1, wherein a blowdown device adapted to filter water impurities is configure on said drainage trough and adjacent to one side of said first drainage portion.

8. The structure according to claim 1, wherein at least one sterilizing light generation device adapted to illuminate inward is configured on one side of said drainage trough.

9. The structure according to claim 1, wherein said first drainage portion and second drainage portion are respectively connected with a first water gate and second water gate, said first and second water gate is in data connection with a control device driving said first and second water gates to move synchronously so as to control water flow rates of said reservoir and drainage trough.

10. The structure according to claim 1, wherein an external water supply device is configured on one side of said reservoir, and a connection portion adapted to connect external facilities in series is formed on one side of said drainage trough
